(19) United States
(12) Patent Application Publication
(10) Pub. No.: US 2014/0112773 A1
(43) Pub. Date: Apr. 24, 2014

(54) CENTRIFUGAL GAS COMPRESSOR WITH A HARDENED SHAFT FOR A BEARING SYSTEM

(71) Applicant: SOLAR TURBINES INCORPORATED, San Diego, CA (US)

(72) Inventors: Gordon E. Brailean, San Diego, CA (US); William Courtney Krehbiel, San Marcos, CA (US); Jess Lee Freeman, Poway, CA (US)

(73) Assignee: Solar Turbines Incorporated, San Diego, CA (US)

(21) Appl. No.: 13/656,281

(22) Filed: Oct. 19, 2012

(51) Int. Cl. F04D 29/05; F16C 3/02; F04D 29/056

(52) U.S. Cl. 415/229; 464/179

(57) ABSTRACT

A shaft (120) configured to be mounted within a centrifugal gas compressor (100) includes a suction end (116), a discharge end (117), and a shaft surface. The shaft surface includes a hardened surface (123) located between the suction end (116) and the discharge end (117). The hardened surface (123) is a localized portion of the shaft surface having a different surface treatment than a remainder of the shaft surface. The hardened surface (123) is harder than the remainder of the shaft surface. The hardened surface (123) is configured to axially align with a central auxiliary bearing (137).

### TECHNICAL FIELD

The present disclosure generally pertains to centrifugal gas compressors, and is more particularly directed toward an auxiliary bearing landing surface of a centrifugal gas compressor magnetic bearing.

### BACKGROUND

The use of magnetic bearings in rotary machines such as centrifugal gas compressors is increasing. Magnetic bearings work on the principle of electromagnetic suspension. The use of electromagnetic suspension reduces or eliminates friction losses in centrifugal gas compressors.

Magnetic bearings in rotary machines are generally arranged with multiple windings or electric coils surrounding a shaft formed from a ferromagnetic material. Some magnetic bearings use a ferromagnetic lamination on the shaft when the shaft is not formed from a ferromagnetic material. The windings in a radial magnetic bearing radially surround the shaft and produce a magnetic field that tends to attract the rotor shaft. The attractive forces of the windings may be controlled by varying the current in each winding. In some instances magnetic bearings may lose power and temporarily stop working. Secondary or auxiliary bearings may be provided for such instances.

U.S. Pat. No. 6,987,339, to R. Adams discloses a bearing for a high-speed and high-momentum rotating flywheel system for satellite or other applications that enables better recovery when unintended physical contact occurs. This better recovery is achieved through increased impact resistance and wear resistance by using a flat annulus connected to the main shaft of the primary bearing and secondary metal bearing and coating both annuli with rhenium or its alloys.

The present disclosure is directed toward overcoming one or more of the problems discovered by the inventors.

### SUMMARY OF DISCLOSURE

A centrifugal gas compressor shaft configured to be mounted within a centrifugal gas compressor includes a suction end, a discharge end, and a shaft surface. The centrifugal gas compressor has a central auxiliary bearing located between a suction end radial bearing and a discharge end radial bearing. The discharge end is distal to the suction end. The shaft surface includes a hardened surface located between the suction end and the discharge end. The hardened surface is a localized portion of the shaft surface having a different surface treatment than a remainder of the shaft surface. The hardened surface is harder than the remainder of the shaft surface. The hardened surface is configured to axially align with a central auxiliary bearing.

### BRIEF DESCRIPTION OF THE DRAWINGS

FIG. 1 is a cutaway illustration of an exemplary centrifugal gas compressor.

FIG. 2 is a partial cross-sectional view of a suction end of a centrifugal gas compressor including a magnetic bearing and an auxiliary bearing.

FIG. 3 is a partial cross-sectional view of a discharge end of a centrifugal gas compressor including a magnetic bearing and an auxiliary bearing.

### DETAILED DESCRIPTION

The systems and methods disclosed herein include an auxiliary bearing system of a centrifugal gas compressor magnetic bearing system. In embodiments, the auxiliary bearing system may be configured with multiple bearings, multiple landing guards, and a hardened surface on the centrifugal gas compressor shaft.

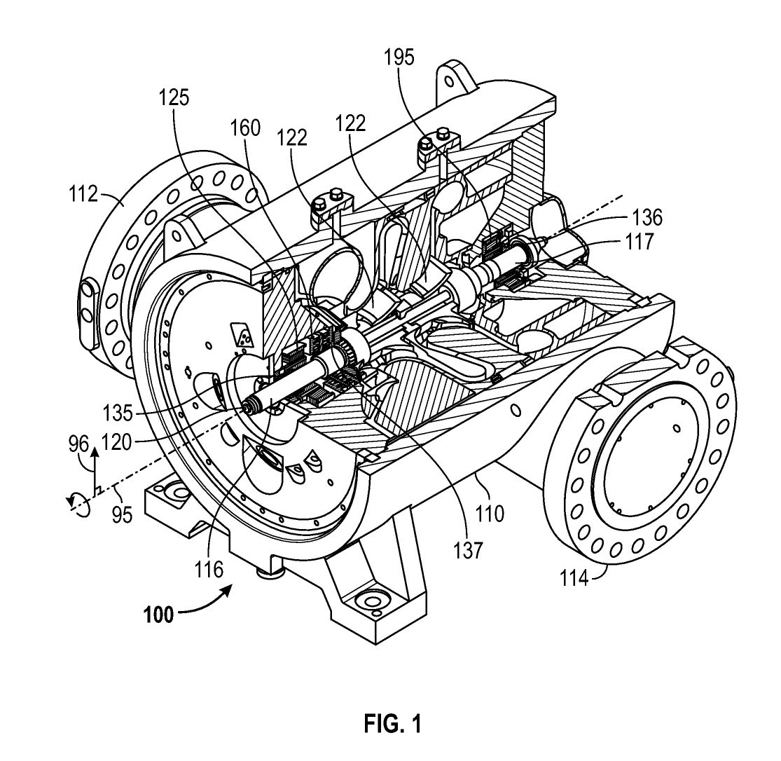

FIG. 1 is a cutaway illustration of an exemplary centrifugal gas compressor 100. Some of the surfaces have been left out or exaggerated (here and in other figures) for clarity and ease of explanation. Also, the disclosure may reference a forward and an aft direction. Generally, all references to “forward” and “aft” are associated with the flow direction of the compressed air with the suction end of the centrifugal gas compressor being considered the forward end and the discharge end being considered the aft end, unless specified otherwise.

In addition, the disclosure may generally reference a center axis 95 of rotation of the centrifugal gas compressor, which may be generally defined by the longitudinal axis of its shaft 120. The center axis 95 may be common to or shared with various other concentric components of the centrifugal gas compressor. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

Centrifugal gas compressor 100 includes housing 110, suction port 112, discharge port 114, centrifugal impellers 122, shaft 120, and a bearing system. Process gas enters the centrifugal gas compressor 100 at a suction port 112 formed on a housing 110. The process gas is compressed by one or more centrifugal impellers 122 mounted to a shaft 120. The compressed process gas exits the centrifugal gas compressor 100 at a discharge port 114 that is formed on the housing 110. Shaft 120 may include suction end 116 and discharge end 117, discharge end 117 being distal to suction end 116. Shaft 120 may be a single shaft or dual shaft configuration. In a dual shaft configuration, shaft 120 may include a suction end stubshaft and a discharge end stub shaft.

Shaft 120 and attached elements may be supported by the bearing system. The bearing system may include suction end radial bearing 125, discharge end radial bearing 195, thrust bearing 160, and an auxiliary bearing system. Suction end radial bearing 125 and discharge end radial bearing 195 support axial ends of shaft 120. In the embodiment shown, suction end radial bearing 125, discharge end radial bearing 195, and thrust bearing 160 are magnetic bearings.

The auxiliary bearing system may include suction end auxiliary bearing 135, discharge end auxiliary bearing 136, and central auxiliary bearing 137. Suction end auxiliary bearing 135, discharge end auxiliary bearing 136, and central auxiliary bearing 137 may be angular contact bearings. In one embodiment, suction end auxiliary bearing 135, discharge end auxiliary bearing 136, and central auxiliary bearing 137 are ball bearings. Suction end auxiliary bearing 135 may be located adjacent suction end radial bearing 125. Discharge end auxiliary bearing 136 may be located adjacent discharge end radial bearing 195.

Central auxiliary bearing 137 may be located between suction end 116 and discharge end 117. Central auxiliary bearing 137 may also be located between suction end radial bearing 125 and discharge end radial bearing 195. Central auxiliary bearing 137 may also be located axially inward from suction end radial bearing 125, discharge end radial bearing 195, and thrust bearing 160.

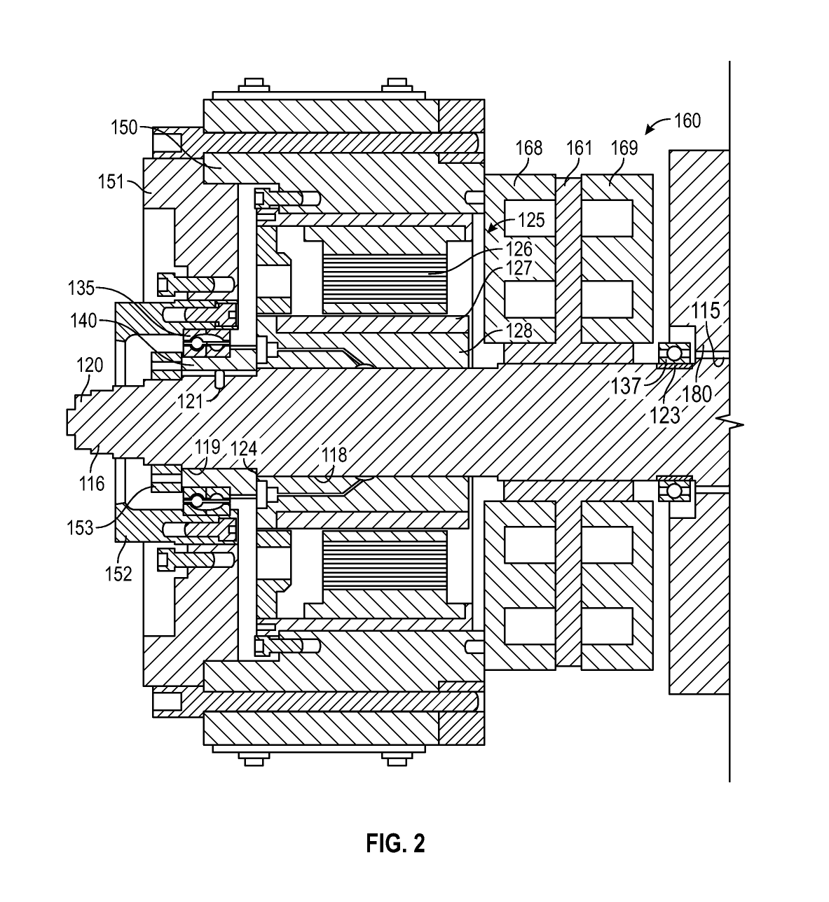

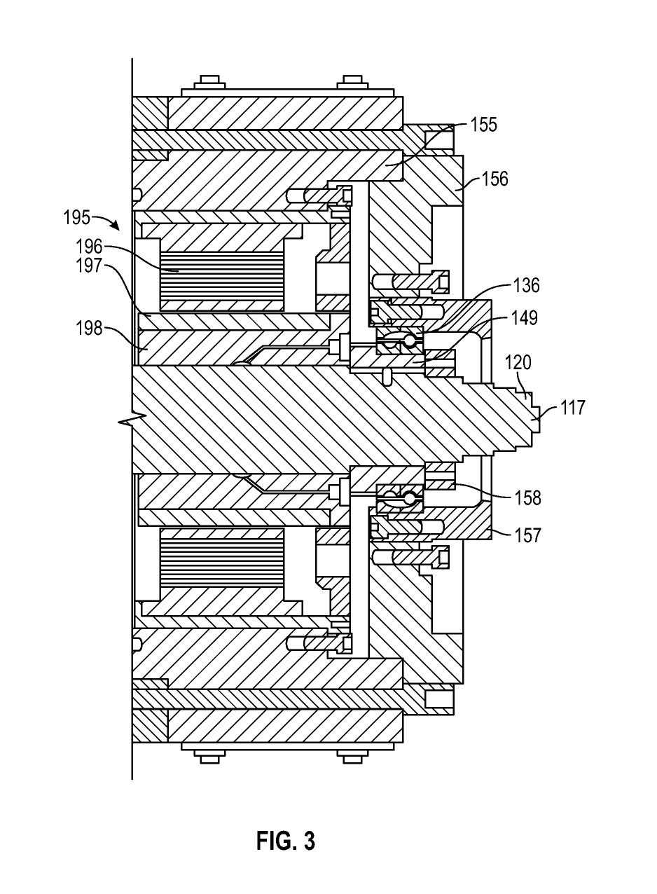

The auxiliary bearing system may also include suction end landing guard 140 (shown in FIG. 2), discharge end landing guard 149 (shown in FIG. 3) and hardened surface 123 (shown in FIG. 2). Suction end landing guard 140 may be located on shaft 120 proximal suction end 116, radially inward from suction end auxiliary bearing 135. Suction end landing guard 140 may be axially aligned with suction end auxiliary bearing 135. Discharge end landing guard 149 may be located on shaft 120 proximal discharge end 117 radially inward from discharge end auxiliary bearing 136. Discharge end landing guard 149 may be axially aligned with discharge end auxiliary bearing 136. Suction end landing guard 140 and discharge end landing guard 149 may be installed onto shaft 120 with a thermal interference fit. Suction end landing guard 140 may be installed between shaft 120 and the suction end auxiliary bearing 135. Discharge end landing guard 149 may be installed between shaft 120 and discharge end auxiliary bearing 136.

Hardened surface 123 is on shaft 120 between suction end 116 and discharge end 117. Hardened surface 123 may also be located axially between suction end radial bearing 125 and discharge end radial bearing 195. Hardened surface may also be located axially inward from suction end radial bearing 125, discharge end radial bearing 195, and thrust bearing 160. Hardened surface 123 may be located radially inward from central auxiliary bearing 137 and axially aligned with central auxiliary bearing 137. In one embodiment, hardened surface 123 is located on a suction end stubshaft. In another embodiment, hardened surface 123 is located on a discharge end stubshaft.

FIG. 2 is a partial cross-sectional view of the suction end of the centrifugal gas compressor 100. In particular, the suction end of the centrifugal gas compressor 100 schematically illustrated in FIG. 1 is shown here in greater detail, including suction end radial bearing 125, thrust bearing 160, and portions of the auxiliary bearing system.

In the embodiment depicted in FIG. 2, suction end radial bearing 125 is located near suction end 116 axially aft of suction end auxiliary bearing 135. Suction end radial bearing 125 may include suction end lamination sleeve 128, suction end lamination 127, and suction end windings 126. Suction end lamination sleeve 128 may be installed onto shaft 120 with an interference fit. An inner surface of suction end lamination sleeve 128 contacts region 118 of shaft 120. Suction end lamination sleeve 128 may include a flange extending radially outward at the forward end. Generally suction end lamination sleeve 128 will not include ferromagnetic materials.

Suction end lamination 127 is located radially outward from suction end lamination sleeve 128. Suction end lamination 127 is attached or coupled to suction end lamination sleeve 128 at an outer surface of suction end lamination sleeve 128 and may be adjacent to the flange on suction end lamination sleeve 128. Suction end lamination 127 includes ferromagnetic materials. Suction end lamination 127 may include suction end lamination outer surface, the radially outermost surface of suction end lamination 127.

Suction end windings 126 are located radially outward from suction end lamination 127 and are axially aligned with suction end lamination 127. Each suction end winding 126 may include a suction end winding inner surface, the radially innermost surfaces of suction end windings 126.

Suction end windings 126 and suction end lamination 127 are configured with a radial clearance there between. The suction end windings inner surfaces are offset from suction end lamination outer surface, forming a suction end magnetic gap. Suction end magnetic gap is an annular gap between suction end windings 126 and suction end lamination 127. The height of suction end magnetic gap may be the radial distance between the suction end windings inner surfaces and suction end lamination outer surface. Suction end windings 126 may be circumscribed by endcap 150.

In the embodiment depicted in FIG. 2, thrust bearing 160 is located axially aft of and adjacent to suction end radial bearing 125. Thrust bearing 160 includes thrust disk 161, forward bearing pole 168, and aft bearing pole 169. A disk portion of thrust disk 161 extends radially outward between forward bearing pole 168 and aft bearing pole 169. Forward bearing pole 168 is located axially forward of the disk portion of thrust disk 161 with an axial gap there between, and aft bearing pole 169 is located axially aft of the disk portion of thrust disk 161 with an axial gap there between.

As previously mentioned, the auxiliary bearing system may include central auxiliary bearing 137, hardened surface 123, suction end auxiliary bearing 135, and suction end landing guard 140. Central auxiliary bearing 137 may be located between suction end 116 and discharge end 117. In the embodiment depicted if FIG. 2, central auxiliary bearing 137 may be located axially aft of thrust bearing 160. In other embodiments, central auxiliary bearing 137 may be located adjacent suction end radial bearing 125 or adjacent discharge end radial bearing 195.

In the embodiment shown in FIG. 2, central auxiliary bearing 137 is located radially outward from shaft 120. Central auxiliary bearing 137 and shaft 120 are configured with a radial clearance there between. As part of the auxiliary bearing system, shaft 120 includes hardened surface 123. Hardened surface 123 is a localized, annular portion of the surface of shaft 120. Hardened surface 123 may have a different surface treatment than the remainder of the surface of shaft 120. Hardened surface 123 may be harder than the remainder of shaft 120. Hardened surface 123 is axially aligned with central auxiliary bearing 137. The axial length of hardened surface 123 may be longer than the axial length of central auxiliary bearing 137.

Hardened surface 123 may be hardened by a hardening process such as induction hardening or by applying a coating material such as tungsten carbide. In one embodiment, hardened surface 123 is hardened by a hardening process and by applying a coating material, such as tungsten carbide or nitride, to shaft 120.

Central auxiliary bearing 137 may include a central inner bearing face, the radially innermost surface of central auxiliary bearing 137. Central inner bearing face is offset from hardened surface 123, forming a central auxiliary gap. The central auxiliary gap is an annular gap between shaft 120 and central auxiliary bearing 137. The height of central auxiliary gap may be the radial distance between hardened surface 123 and central inner bearing face.

Suction end auxiliary bearing 135 may be located axially forward of suction end radial bearing 125. Suction end auxiliary bearing 135 may comprise multiple bearings. In one embodiment, suction end auxiliary bearing 135 includes a tandem pair of bearings. Suction end auxiliary bearing 135 may include a suction end inner bearing surface, the radially innermost surface of suction end auxiliary bearing 135.

Suction end landing guard 140 is installed onto shaft 120 between suction end auxiliary bearing 135 and shaft 120. Suction end auxiliary bearing 135 is located radially outward from suction end landing guard 140 with a radial clearance there between. Suction end landing guard 140 may include a suction end landing surface, a radially outer surface of suction end landing guard 140 that is axially aligned with suction end auxiliary bearing 135. Suction end landing surface is offset from suction end inner bearing surface, forming a suction end auxiliary gap. The suction end auxiliary gap is an annular gap between suction end landing guard 140 and suction end auxiliary bearing 135. The height of suction end auxiliary gap may be the radial distance between suction end inner bearing surface and suction end landing surface. The height of the suction end auxiliary gap is less than the height of the suction end magnetic gap.

In the embodiment shown in FIG. 2, suction end landing guard 140 is an L-shaped landing guard. Suction end landing guard 140 may be located axially forward of suction end lamination sleeve 128. Suction end landing guard 140 may include an inner surface.

Shaft 120 may include a first region generally indicated as 118 and a second region generally indicated as 119. A shelf 124 forms the transition between these two regions, and extends radially outward from region 119 to region 118 in a direction orthogonal to the surfaces of the regions. The outer diameter of region 119 is smaller than the outer diameter of region 118. Region 119 is located axially forward of region 118. The varying diameters of shaft 120 may facilitate the installation of suction end radial bearing 125. In the embodiment shown in FIG. 2, the inner surface 143 of suction end landing guard 140 contacts region 119 of shaft 120, and an aft end of suction end landing guard 140 abuts shelf 124 and a forward end of suction end lamination sleeve 128. Shaft 120 may also include central bearing step 115. Central bearing step 115 may be located adjacent hardened surface 123. The outside diameter of central bearing step 115 may be larger than the outside diameter of hardened surface 123.

One or more pins 121 may be installed into shaft 120 within region 119 of shaft 120. Pins 121 may be cylindrically shaped with rounded ends. Pins 121 may interface with a slot in suction end landing guard 140 when suction end landing guard 140 is installed to shaft 120.

The slot is an axial channel extending along the inner surface of suction end landing guard 140 and may extend from an end of suction end landing guard 140. The slot extends far enough along the inner surface for suction end landing guard 140 to receive a pin 121 when suction end landing guard 140 is installed onto shaft 120.

The centrifugal gas compressor 100 may also include endcaps 151, 152, and 153, as well as separation seal 180. Endcaps 151, 152, and 153 may be installed at the forward end of the centrifugal gas compressor 100. Endcap 153 is located forward of suction end landing guard 140 and radially outward from shaft 120. Endcap 152 axially overlaps with suction end landing guard 140 and is located radially outward from endcap 153 and suction end landing guard 140. Endcap 151 is located forward of suction end windings 126 and radially outward from endcap 152. Separation seal 180 may be located axially aft of thrust bearing 160 and central auxiliary bearing 137.

FIG. 3 is a partial cross-sectional view of the discharge end of the centrifugal gas compressor 100. In particular, the discharge end of the centrifugal gas compressor 100 schematically illustrated in FIG. 1 is shown here in greater detail, including discharge end radial bearing 195 and portions of the auxiliary bearing system.

In the embodiment depicted in FIG. 3, discharge end radial bearing 195 is located near discharge end 117 axially forward of discharge end auxiliary bearing 136. Discharge end radial bearing 195 may include discharge end lamination sleeve 198, discharge end lamination 197, and discharge end windings 196. Discharge end lamination sleeve 198 may be installed onto shaft 120 in a similar manner or in the same manner as suction end lamination sleeve 128, as discussed above. Similar to suction end lamination sleeve 128, discharge end lamination sleeve 198 will generally not include ferromagnetic materials.

Discharge end lamination 197 is located radially outward from discharge end lamination sleeve 198 and may be attached or coupled to discharge end lamination sleeve 198 in a similar manner or in the same manner as suction end lamination 127 is attached or coupled to suction end lamination sleeve 128, as discussed above. Discharge end lamination 197 also includes ferromagnetic materials. Discharge end lamination 197 may include discharge end lamination outer surface, the radially outermost surface of discharge end lamination 197.

Discharge end windings 196 are located radially outward from discharge end lamination 197 and are axially aligned with discharge end lamination 197. Each discharge end winding 196 may include a discharge end winding inner surface, the radially innermost surfaces of discharge end windings 196.

Discharge end windings 196 and discharge end lamination 197 are configured with a radial clearance there between. The discharge end winding inner surfaces are offset from discharge end lamination outer surface, forming a discharge end magnetic gap. Discharge end magnetic gap is an annular gap between discharge end windings 196 and discharge end lamination 197. The height of discharge end magnetic gap may be the radial distance between discharge end winding inner surfaces and discharge end lamination outer surface. Discharge end windings 196 may be circumscribed by endcap 155.

As previously mentioned, the auxiliary bearing system may include discharge end auxiliary bearing 136 and a discharge end landing guard 149. Discharge end auxiliary bearing 136 may be located axially aft of discharge end radial bearing 195. Discharge end auxiliary bearing 136 may comprise multiple bearings. In one embodiment, discharge end auxiliary bearing 136 includes a tandem pair of bearings. Discharge end auxiliary bearing 136 may include discharge end inner bearing surface, the radially innermost surface of discharge end auxiliary bearing 136.

Discharge end landing guard 149 is installed onto shaft 120 between discharge end auxiliary bearing 136 and shaft 120. Discharge end auxiliary bearing 136 is located radially outward from discharge end landing guard 149 with a radial clearance there between. Discharge end landing guard 149 may include a discharge end landing surface, a radially outer surface of discharge end landing guard 149 that is axially aligned with discharge end auxiliary bearing 136. Discharge end landing surface is offset from discharge end inner bearing surface, forming a discharge end auxiliary gap. The discharge end auxiliary gap is an annular gap between discharge end landing guard 149 and discharge end auxiliary bearing 136. The height of discharge end auxiliary gap may be the radial distance between discharge end inner bearing surface and discharge end landing surface. The height of the discharge end auxiliary gap is less than the height of the discharge end magnetic gap.

In the embodiment shown in FIG. 3, discharge end landing guard 149 is an L-shaped landing guard. Discharge end landing guard 149 may be located axially aft of discharge end lamination sleeve 198. Discharge end landing guard 149 may be installed onto shaft 120 in a similar manner or in the same manner as suction end landing guard 140, as discussed above.

The centrifugal gas compressor 100 may also include endcaps 156, 157, and 158. Endcaps 156, 157, and 158 may be installed at the aft end of the centrifugal gas compressor 100. Endcap 158 is located aft of discharge end landing guard 149 and radially outward from shaft 120. Endcap 157 axially overlaps with discharge end landing guard 149 and is located radially outward from endcap 158 and discharge end landing guard 149. Endcap 156 is located aft of discharge end windings 196 and radially outward from endcap 157.

As previously mentioned, suction end landing guard 140 and a discharge end landing guard 149 may be an L-shaped landing guard. An L-shaped landing guard is configured with a landing portion and a flange. The landing portion generally has a tubular shape. The tubular shape being a thickened and elongated circular shape such as a hollow cylinder. The landing portion includes a landing surface, the radially outer cylindrical surface of the landing portion. The landing surface may be hardened by a hardening process and by applying a coating material to landing surface.

The flange is located at the aft end of an L-shaped suction end landing guard 140 and at the forward end of an L-shaped discharge end landing guard 149. The flange extends radially outward beyond the landing surface and is located adjacent the landing surface. The cross-section of the L-shaped landing guard with the flange is generally an L-shape. The flange may include threads. The threads are located on the radially outer surface of the flange. An L-shaped landing guard may be manufactured as a single piece.

The materials used to manufacture suction end landing guard 140 or discharge end landing guard 149 may match the materials used to manufacture shaft 120. Suction end landing guard 140 and discharge end landing guard 149 may also be manufactured from AISI 4140 steel and may also be a non-ferromagnetic material. A landing guard manufactured from ferromagnetic materials may interfere with the operation of the radial magnetic bearings.

### INDUSTRIAL APPLICABILITY

Centrifugal gas compressors are used to move process gas from one location to another. Centrifugal gas compressors are often used in the oil and gas industries to move natural gas in a processing plant or in a pipeline. Centrifugal gas compressors are driven by gas turbine engines, electric motors, or any other power source.

There is a desire to achieve greater efficiencies and reduce emissions in large industrial machines such as centrifugal gas compressors. Installing magnetic bearings in a centrifugal gas compressor may accomplish both desires. Centrifugal gas compressors may achieve greater efficiencies with magnetic bearings by eliminating any contact between the bearings and rotary element. Contact between the bearings and the rotary element generally causes frictional losses to occur. Magnetic bearings may use electromagnetic forces to levitate and support the rotary element without physically contacting the rotary, element eliminating the frictional losses.

Using magnetic bearings may reduce or eliminate production of undesirable emissions. These emissions may be produced by leaking or burning a lubricant such as oil. Eliminating the contact and frictional losses between the rotary element and bearings by supporting the rotary element with magnetic bearings may eliminate or reduce the need for lubricants in centrifugal gas compressors. With this elimination or reduction of lubricants or oil, the emissions in centrifugal gas compressors may be reduced or eliminated. Eliminating lubricants may also eliminate the need for the valves, pumps, filters, and coolers associated with lubrication systems.

In centrifugal gas compressor 100, the magnetic bearing system, including suction end radial bearing 125 and discharge end radial bearing 195, supports shaft 120 radially using magnetic levitation. Suction end radial bearing 125 uses suction end windings 126 and discharge end radial bearing 195 uses discharge end windings 196. Suction end windings 126 and discharge end windings 196 are electromagnets that produce a magnetic field. The magnetic field is generated by the electrical currents traversing suction end windings 126 and discharge end windings 196. The attractive force of each suction end winding 126 and each discharge end winding 196 may be controlled by varying the electric current traversing suction end windings 126 and discharge end windings 196. The magnetic field produced by suction end windings 126 and discharge end windings 196 interact with the ferromagnetic material of suction end lamination 127 and discharge end lamination 197 respectively. The magnetic forces act on shaft 120 through suction end lamination 127 and discharge end lamination 197 to levitate shaft 120 without any contact between suction end windings 126 and suction end lamination 127, and discharge end windings 196 and discharge end lamination 197.

Designing a magnetic bearing system to replace mechanical bearings in centrifugal gas compressors does not come without its challenges. Magnetic bearings may lose power or fail. Without radial support from the magnetic bearings shaft 120 may be damaged when shaft 120 falls and contacts elements of the magnetic bearings or elements of the centrifugal gas compressor.

The auxiliary bearing system, including suction end auxiliary bearing 135, discharge end auxiliary bearing 136, and central auxiliary bearing 137, is installed in centrifugal gas compressor 100. The auxiliary bearing system prevents shaft 120 from contacting the magnetic bearing system or other parts of centrifugal gas compressor 100 when suction end radial bearing 125 or discharge end radial bearing 195 fail or lose power. However, suction end auxiliary bearing 135, discharge end auxiliary bearing 136, or central auxiliary bearing 137 may damage shaft 120 if shaft 120 drops onto suction end auxiliary bearings 135, discharge end auxiliary bearing 136, or central auxiliary bearing 137.

Suction end landing guard 140 may be coupled to shaft 120 between shaft 120 and suction end auxiliary bearing 135. When suction end radial bearing 125 loses power or shuts off, suction end landing surface of suction end landing guard 140 may act as a landing area and may contact suction end auxiliary bearing 135. Suction end auxiliary bearings 135 may support shaft 120 through contact with suction end landing guard 140 until suction end radial bearing 125 is reactivated.

Similarly, discharge end landing guard 149 may be coupled to shaft 120 between shaft 120 and discharge end auxiliary bearing 136. When discharge end radial bearing 195 loses power or shuts off, discharge end landing surface of discharge end landing guard 149 may act as a landing area and may contact discharge end auxiliary bearing 136. Discharge end auxiliary bearings 136 may support shaft 120 through contact with discharge end landing guard 149 until discharge end radial bearing 195 is reactivated.

It was determined through research and development that hardened surface 123 should be used with central auxiliary bearing 137, rather than a landing guard or sleeve. Standard industry practice is to use a landing guard or sleeve permanently mounted to the shaft with central auxiliary bearing 137. A larger landing guard or sleeve inner diameter may improve bending modes, while a landing guard or sleeve with a smaller inner diameter installed on shaft 120 may result in an uncontrollable compressor with high vibrations. A thin landing guard or sleeve may not be durable enough to be used as a sacrificial piece within the centrifugal gas compressor 100.

A larger inner diameter combined with a thicker landing guard or sleeve may increase the outer diameter of the landing guard to a size greater than the inner diameter of centrifugal gas compressor 100 components such as the dry gas seal inner diameter. A landing guard or sleeve with an outer diameter larger than components such as the dry gas seal may increase manufacturing and repair costs; shaft 120 may not be easily removed increasing the complexity of centrifugal gas compressor 100 assembly and disassembly. Use of hardened surface 123 at central auxiliary bearing 137 may result in a stable centrifugal gas compressor with reduced assembly and repair costs.

The hardening process or coating may provide hardened surface 123 with the hardness needed for hardened surface 123 to protect shaft 120 from impact damage at central auxiliary bearing 137. Suction end landing guard 140 may protect shaft 120 from impact damage at suction end auxiliary bearing 135 and discharge end landing guard 149 may protect shaft 120 from impact damage at discharge end auxiliary bearing 136. Hardened surface 123, suction end landing guard 140, and discharge end landing guard 149 may collectively protect shaft 120 from significant damage that may result in the need for repair or replacement of shaft 120.

Damage to shaft 120 may further be avoided by preventing rotational displacement or slipping between the suction end landing guard 140 and shaft 120, and discharge end landing guard 149 and shaft 120. This may be accomplished by coupling each landing guard to shaft 120 with an interference fit. Each landing guard may be heated to expand the dimensions of the landing guard. The thermally expanded landing guard may then be installed onto shaft 120 and cooled to create the interference fit.

Pins 121 may help prevent a landing guard from rotating relative to shaft 120. As illustrated in FIG. 2, pins 121 may be installed into holes in shaft 120. Each pin 121 protrudes from shaft 120 into a corresponding slot of a landing guard, such as suction end landing guard 140 and discharge end landing guard 149, when the landing guard is installed onto shaft 120. The contacts between the landing guard, shaft 120, and the one or more pins 121 may prevent the landing guard from rotating relative to shaft 120.

As sacrificial pieces, suction end landing guard 140 and discharge end landing guard 149 may need to be replaced during maintenance of centrifugal gas compressor 100. Re-heating suction end landing guard 140 and discharge end landing guard 149 may not be a viable method for removing suction end landing guard 140 and discharge end landing guard 149 from shaft 120. The heat may cause thermal damage to shaft 120. In one embodiment, threads of an L-shaped landing guard are used to couple a removal tool to the L-shaped landing guard to aid in removal of the L-shaped landing guard from shaft 120. Coupling a removal tool to the flange may provide leverage for removing the L-shaped landing guard from shaft 120.

The preceding detailed description is merely exemplary in nature and is not intended to limit the invention or the application and uses of the invention. The described embodiments are not limited to use in conjunction with a particular type of gas compressor. Hence, although the present embodiments are, for convenience of explanation, depicted and described as being implemented in a centrifugal gas compressor, it will be appreciated that it can be implemented in various other types of compressors, and in various other systems and environments. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

What is claimed is:

1. A centrifugal gas compressor shaft configured to be mounted within a centrifugal gas compressor having a central auxiliary bearing located between a suction end radial bearing and a discharge end radial bearing, the centrifugal gas compressor shaft comprising:
a suction end;
a discharge end distal to the suction end; and
a shaft surface, the shaft surface having
a hardened surface located between the suction end and the discharge end, the hardened surface being a localized portion of the shaft surface having a different surface treatment than a remainder of the shaft surface, the hardened surface being harder than the remainder of the shaft surface;
wherein the hardened surface is configured to axially align with the central auxiliary bearing.

2. The shaft of claim 1, wherein the hardened surface is hardened by an induction hardening process.

3. The shaft of claim 1, wherein the hardened surface includes tungsten carbide.

4. The shaft of claim 2, wherein the hardened surface includes tungsten carbide.

5. The shaft of claim 1, wherein a suction end landing guard is located on the shaft proximal the suction end of the shaft and a discharge end landing guard is located on the shaft proximal the discharge end of the shaft.

6. The shaft of claim 1, further comprising:
a suction end stubshaft, wherein the hardened surface is located on the suction end stubshaft.

7. The shaft of claim 1, further comprising:
a discharge end stubshaft, wherein the hardened surface is located on the discharge end stubshaft.

8. The shaft of claim 1, further comprising a central bearing step adjacent the hardened surface, the central bearing step having a step outside diameter larger than that of a hardened surface outside diameter.

9. A centrifugal gas compressor, comprising:
a shaft having
a suction end,
a discharge end, and
a shaft surface;
a suction end radial bearing;
a discharge end radial bearing;
a thrust bearing; and
an auxiliary bearing system having
a suction end landing guard located on the shaft proximal the suction end of the shaft,
a discharge end landing guard is located on the shaft proximal the discharge end of the shaft, and
a hardened surface located on the shaft axially inward from the suction end radial bearing, the discharge end radial bearing, and the thrust bearing, the hardened surface being a localized portion of the shaft surface having a different surface treatment than a remainder of the shaft surface, the hardened surface being harder than the remainder of the shaft surface.

10. The centrifugal gas compressor of claim 9, further comprising:
a central auxiliary bearing located radially outward from the hardened surface and axially aligned with the hardened surface, the central auxiliary bearing and the shaft being configured with a radial clearance there between;
a suction end auxiliary bearing located radially outward from the suction end landing guard and axially aligned with the suction end landing guard, the suction end auxiliary bearing and the suction end landing guard being configured with a radial clearance there between; and
a discharge end auxiliary bearing located radially outward from the discharge end landing guard and axially aligned with the discharge end landing guard, the discharge end auxiliary bearing and the discharge end landing guard being configured with a radial clearance there between.

11. The centrifugal gas compressor of claim 10, wherein the central auxiliary bearing, the suction end auxiliary bearing, and the discharge end auxiliary bearing are angular contact bearings.

12. The centrifugal gas compressor of claim 9, wherein the hardened surface is hardened by an induction hardening process.

13. The centrifugal gas compressor of claim 9, wherein the hardened surface includes tungsten carbide.

14. The centrifugal gas compressor of claim 12, wherein the hardened surface includes tungsten carbide.

15. An auxiliary bearing system of a centrifugal gas compressor, the centrifugal gas compressor includes a shaft with a suction end, a discharge end, and a shaft surface, the auxiliary bearing system comprising:
a suction end landing guard located on the shaft proximal the suction end;
a discharge end landing guard located on the shaft proximal the discharge end; and
a hardened surface located on the shaft between the suction end and the discharge end, the hardened surface being a localized portion of the shaft surface having a different surface treatment than a remainder of the shaft surface, the hardened surface being harder than the remainder of the shaft surface.

16. The auxiliary bearing system of claim 15, wherein the hardened surface is hardened by an induction hardening process.

17. The auxiliary bearing system of claim 15, wherein the hardened surface includes tungsten carbide.

18. The auxiliary bearing system of claim 16, wherein the hardened surface includes tungsten carbide.

19. The auxiliary bearing system of claim 15, further comprising:
a suction end auxiliary bearing located radially outward from the suction end of the shaft, the suction end auxiliary bearing having a radial contact bearing and a suction end inner bearing surface;
a discharge end auxiliary bearing located radially outward from the discharge end of the shaft, the discharge end auxiliary bearing having a radial contact bearing and a discharge end inner bearing surface;
a central auxiliary bearing located radially outward from the shaft and axially aft of the suction end auxiliary bearing, the central auxiliary bearing having a radial contact bearing and a central inner bearing surface;
the suction end landing guard being axially aligned with the suction end auxiliary bearing, the suction end landing guard having
a suction end landing surface, the suction end landing surface being offset from the suction end inner bearing surface, forming a suction end auxiliary gap there between, the suction end auxiliary gap being an annular gap;
the discharge end landing guard being axially aligned with the discharge end auxiliary bearing, the discharge end landing guard having
a discharge end landing surface, the discharge end landing surface being offset from the discharge end inner bearing surface, forming a discharge end auxiliary gap there between, the discharge end auxiliary gap being an annular gap; and
the hardened surface being offset from the central inner bearing surface, forming a central auxiliary gap there between, the central auxiliary gap being an annular gap.

20. A centrifugal gas compressor including the auxiliary bearing system of claim 15.
